(19) United States
(12) Patent Application Publication
(10) Pub. No.: US 2011/0262070 A1
(43) Pub. Date: Oct. 27, 2011

(54) SUSPENSION STRUT BEARING AND MANUFACTURING METHOD FOR A COMPONENT OF A SUSPENSION STRUT BEARING

(75) Inventors: Alexander Zernickel, Herzogenaurach (DE); Ernst Neuwirth, Herzogenaurach (DE)

(73) Assignee: SCHAEFFLER TECHNOLOGIES GMBH & CO. KG, Herzogenaurach (DE)

(21) Appl. No.: 13/091,436

(22) Filed: Apr. 21, 2011

(30) Foreign Application Priority Data
Apr. 21, 2010 (DE) 102010015712.0

(51) Int. Cl. F16C 19/30; B21D 53/10

(52) U.S. Cl. 384/618; 29/898.04

(57) ABSTRACT

A suspension strut bearing (1) is provided with a vehicle-body attachment element (3) and a guide ring (5). A sliding bearing (9) or rolling bearing (11) that can rotate about a center axis (7) is arranged between the vehicle-body attachment element (3) and the guide ring (5). The guide ring (5) has at least one metallic reinforcement (17) and forms an axial and/or radial thrust bearing (13) for a coil spring (15). In addition, a manufacturing method for a component of a suspension strut bearing (1) is provided.

### CROSS-REFERENCE TO RELATED APPLICATIONS

This application claims the benefit of German Patent Application No. 102010015712.0, filed Apr. 21, 2010, which is incorporated herein as if fully set forth.

### BACKGROUND

The present invention relates to a suspension strut bearing with a vehicle-body attachment element and a guide ring. A sliding bearing or rolling bearing that can rotate about a center axis is arranged between the vehicle-body attachment element and the guide ring. The guide ring has at least one metallic reinforcement and forms an axial and/or radial thrust bearing for a coil spring.

The present invention further relates to a manufacturing method for a component of a suspension strut bearing.

A suspension strut bearing is typically used for holding a suspension strut with which, in particular, a guided wheel, for example, of a motor vehicle, is supported relative to a vehicle body. The suspension strut as such here comprises a telescoping shock absorber with a piston rod guided so that it can move in a cylinder and a coil spring that surrounds the shock absorber and is used as a vehicle suspension spring. The coil spring is here set in tension between the spring plate of the suspension strut bearing and another spring plate that is connected to the cylinder of the shock absorber. The suspension strut, i.e., the shock absorber and the coil spring, are thus supported jointly by the suspension strut bearing so that they can rotate relative to the vehicle body. The suspension strut bearing allows a certain freedom of play of the suspension strut, including the spring plate supporting the coil spring, relative to the vehicle body. According to the requirements, the rotating bearing is constructed as a rolling or sliding bearing.

Such a suspension strut bearing is known, for example, from the German Patent DE 37 37 770 C2.

In order to influence a suspension strut in terms of its stiffening effect, i.e., in order to increase, for example, the spring constant, European Patent Application EP 2 128 464 A1 discloses a thrust sliding bearing and a combination mechanism made from the thrust sliding bearing. The thrust sliding bearing comprises a synthetic, ring-shaped, first bearing housing element produced from synthetic resin with a ring-shaped top side, a ring-shaped outer peripheral surface, and a ring-shaped bottom side. In addition, the thrust sliding bearing contains a second synthetic bearing housing element produced from synthetic resin with a ring-shaped bottom side, a metallic plate as a reinforcement element that has a ring-shaped bottom side and also a top side. A synthetic thrust sliding bearing produced from synthetic resin is inserted between the ring-shaped top side of the reinforcement element and the ring-shaped bottom side of the second bearing housing element. In addition, there is a synthetic radial sliding bearing piece produced from synthetic resin, wherein this piece is installed between a ring-shaped, inner peripheral surface of a first cylindrical recess part of the reinforcement element and a ring-shaped, outer peripheral surface of a second cylindrical recess part of the second bearing housing element.

Furthermore, in modern running-gear technology, so-called compression buffers, also called buffer collars, are disclosed. The compression buffer is used to form an elastic end stop in the case of strong compression, wherein the cylinder of the shock absorber contacts the compression buffer. To this end, the compression buffer is produced from a suitable elastomer.

Such a compression buffer is described in the British Patent Application GB 2 347 906 A. Here, a suspension strut bearing is proposed that has a coil spring support surface, a rolling bearing arranged on the coil spring support surface and a metallic carrier arranged on an upper bearing ring of the rolling bearing. The coil spring bearing is made from plastic and is constructed with an inward-directed radial projection on which the compression buffer described above is supported, in order to limit the path of the piston rod of the shock absorber in the case of a strong compression. In this way, an impact of the piston rod of the shock absorber on the base of the shock absorber cylinder is prevented. The bearing rings of the roller bearing are produced as stamped and bent sheet-metal parts.

For such suspension strut bearings known in the prior art, however, the rolling bearing is generally not supplied by the same manufacturer as the upper shock absorber block to which the upper support element belongs. The construction of the rolling bearing allows transport only with difficulty, without being able to avoid the risk of falling out unintentionally. In addition, the strength of the coil spring bearing is sometimes insufficient in the case of excessive compression.

Therefore, suspension strut bearings are also known as disclosed, for example, in German Published Application DE 100 42 677 A1 to which a rolling bearing with one-piece bearing rings produced with metal cutting belongs, in order to prevent loss of elements during the transport of the suspension strut bearing before its installation in the suspension strut. Such suspension strut bearings, however, are cost-intensive and are in no way provided to interact with a compression buffer.

German Utility Model DE 20 2004 011 432 U1 describes a suspension strut bearing that is protected against unintentional disassembly. The suspension strut bearing includes a rolling bearing that forms an axial thrust bearing arranged on a lower support plate for a coil spring. The plate is in the position to change its rotational position together with the coil spring. The rolling bearing contains an upper bearing ring and a lower bearing ring that is in contact with the lower plate. The thrust bearing is equipped with means, in order to hold the rolling bearing together with the lower plate. The lower plate includes a base body made from deformable plastic and a metallic reinforcement insert embedded in the base body, wherein the base body has a lower support surface for a compression buffer and the lower surface has a smaller diameter than the diameter of a support region of the lower bearing ring of the rolling bearing on the lower plate. The compression buffer itself could be placed in a cylindrical drill hole that is included in a projection that extends downward in the axial direction and forms a portion of the base body or in the cylindrical drill hole of a projection extending inward in the radial direction, in that the lower plate is equipped with a deep-drawn metal insert. In this way, a robust plate is created that is suitable for absorbing the axial forces that are exerted on the lower surface in the vicinity of an inner wheel.

Despite these constructions of suspension strut bearings already adapted to the high demands, the cost-benefit factor is gaining more and more importance, wherein, especially due to the involvement of a wide range of manufacturers, high costs are generated due to the manufacturing of various individual parts for a suspension strut. In addition, individual parts that support a suspension strut bearing in terms of its functioning are often left out due to high assembly costs.

### SUMMARY

The object of the present invention is to create a suspension strut bearing that can be manufactured economically and easily, wherein noise-damping and stiffening properties are simultaneously fulfilled by the suspension strut bearing.

This objective is met by a suspension strut bearing according to the invention.

Another object of the invention is to provide a manufacturing method for a component of a suspension strut bearing, wherein this method produces, economically and easily, a guide ring with which noise-damping and stiffening properties are simultaneously fulfilled by the suspension strut bearing.

This objective is met by a manufacturing method according to the invention.

The suspension strut bearing of the present invention comprises a vehicle-body attachment element and a guide ring. A sliding bearing or rolling bearing that can rotate about a center axis is arranged between the vehicle-body attachment element and the guide ring. The guide ring that has at least one metallic reinforcement forms an axial and/or radial thrust bearing for a coil spring, in order to guarantee a greater resistance capacity with respect to the mechanical loading during use of a suspension strut bearing.

According to the invention, the guide ring that is advantageously produced from plastic is formed as a single component that comprises at least one damping layer and the at least one metallic reinforcement. Due to the construction as a one-piece component, the guide ring, the at least one metallic reinforcement, and the at least one damping layer are connected to each other in a non-detachable way.

Advantageously, therefore, the at least one metallic reinforcement is extrusion-coated with the material of the guide ring and the at least one damping layer is injection-molded on the guide ring, wherein the advantages of the invention emerge especially strongly if the at least one damping layer is made from a softer plastic material than that of the guide ring. Furthermore, the at least one damping layer has the property that it achieves an oscillation-damping or noise-damping effect between the coil spring and the suspension strut bearing, for example, for the use of a motor vehicle, wherein a shock absorber and the coil spring are supported jointly by the suspension strut bearing so that they can rotate relative to the vehicle body.

Such methods of extrusion-coating and injection-molding of components and molded parts are known on the market and are in use in many forms and constructions. They are often used when high requirements are placed on the components and molded parts and one material can no longer fulfill these requirements.

Of special interest here is the plastic-metal connection, i.e., the connection of the at least one metallic reinforcement with the material of the guide ring, which allows, through one extrusion-coating process, the manufacture of a complex and assembly-ready component in one production step. It can also be further recognized that through the injection-molding process described above, i.e., the connection of the at least one damping layer on the guide ring to the already at least one embedded metallic reinforcement, all of the work processes relevant to the guide ring can be performed in one continuous work process by an injection mold, such as, for example, by a multi-component injection-molding method.

For multi-component injection-molding methods, there are various types of injection molding that all have in common that injection molds are needed with two or also more injection units, but optionally only one injection unit is needed. The injection units must work in sync, but can always be controlled independently of each other. The components can be injection molded by a special nozzle or placed into the tool at different positions.

It is obvious for someone skilled in the art that other component connection methods could also be used in the invention, because, in the prior art, the plastic and also metal processing technology discloses other methods that could be used for the invention for the non-detachable connection of components and molded parts.

For a first embodiment of the invention, the at least one damping layer is oriented in the radial direction relative to the center axis of the suspension strut bearing. The damping layer thus forms a radial thrust bearing for the coil spring of the suspension strut. It is likewise conceivable that in another embodiment of the invention, the at least one damping layer is oriented in the radial and axial direction relative to the center axis of the suspension strut bearing. The damping layer thus forms a radial and axial thrust bearing for the coil spring of the suspension strut. First, due to the arrangement of the at least one damping layer as a thrust bearing, the production costs can be reduced, because relatively simple molds and methods can be used for the production of such a suspension strut bearing. Second, according to the first embodiment in the radial direction relative to the center axis or according to the second embodiment in the radial and axial direction relative to the center axis, an oscillation-damping or noise-damping effect as described above is achieved between a coil spring and the suspension strut bearing.

For the case that the suspension strut bearing comprises a sliding bearing, a sliding element allocated to the sliding bearing is arranged in the radial and axial direction relative to the center axis of the suspension strut bearing, so that the suspension strut bearing absorbs axial and/or radial forces. Such sliding elements are disclosed sufficiently in the prior art, so that the suspension strut bearing is designed for average to high loading.

The manufacturing method of the component of a suspension strut bearing according to the invention is characterized in that at least one metallic reinforcement is extrusion-coated with the material of a guide ring. Then at least one damping layer is injection-molded on the guide ring as an axial and/or radial thrust bearing for a coil spring, wherein the extrusion-coating of the at least one reinforcement and the injection-molding of the at least one damping layer are carried out in one injection mold. Advantageously, the extrusion-coating and injection-molding are created in one mold by a multi-component injection-molding process.

### BRIEF DESCRIPTION OF THE DRAWINGS

Embodiments of the invention and their advantages shall be explained in detail below with reference to the accompanying figures. The size ratios in the figures do not always correspond to the real size ratios, because some shapes are shown simplified and other shapes are shown enlarged with respect to other elements for better illustration. Shown herein are:

FIG. 1 is a longitudinal section view taken along the center axis of a first embodiment of the suspension strut bearing according to the invention with a sliding bearing;

FIG. 2 is a longitudinal section view taken along the center axis of a second embodiment of the suspension strut bearing according to the invention with a sliding bearing; and

FIG. 3 is a longitudinal section view taken along the center axis of a suspension strut bearing according to the invention with a rolling bearing.

### DETAILED DESCRIPTION OF THE PREFERRED EMBODIMENTS

For elements of the invention that are identical or have identical actions, identical reference symbols are used. Furthermore, for the sake of clarity, only reference symbols that are required for the description of the figure are shown in each of the figures. The illustrated embodiments merely represent examples of how the suspension strut bearing according to the invention and the manufacturing method according to the invention could be equipped for one component of a suspension strut bearing; thus they represent absolutely no restriction to the invention.

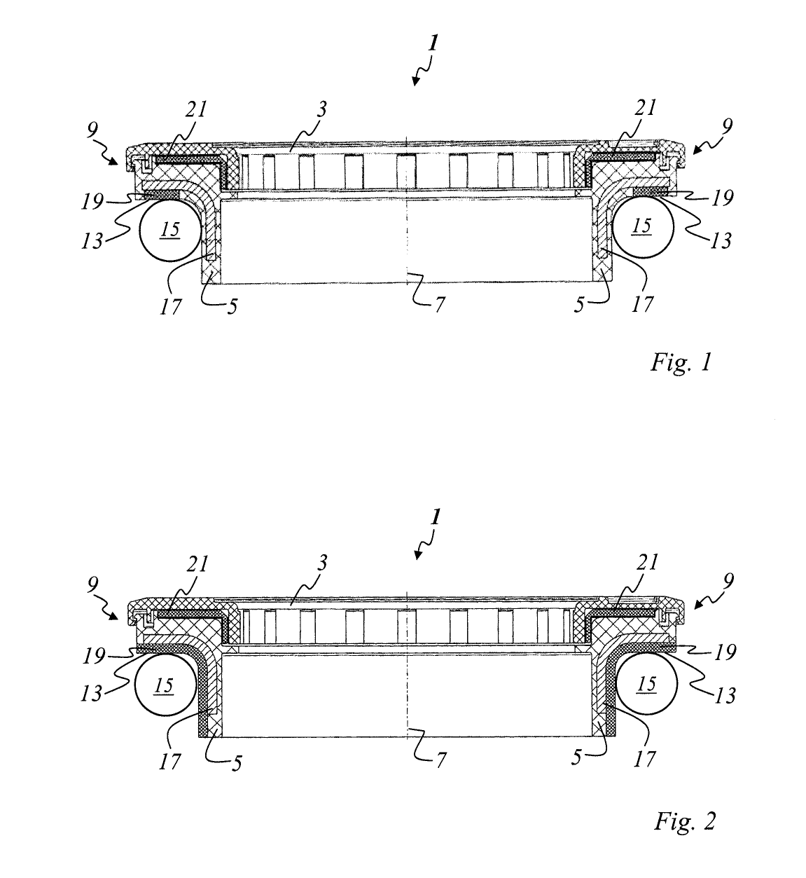

FIG. 1 shows a first embodiment of the suspension strut bearing 1 according to the invention with a sliding bearing 9 in a longitudinal section along the center axis 7, wherein the suspension strut bearing 1 comprises a vehicle-body attachment element 3 and a guide ring 5. A sliding element 21 arranged in the radial and axial direction relative to the center axis 7 of the suspension strut bearing 1 is allocated to the sliding bearing 9, so that the suspension strut bearing 1 absorbs axial and/or radial forces. The guide ring 5 has a metallic reinforcement 17, so that a greater resistance capacity with respect to the mechanical loading during use of a suspension strut bearing 1 is guaranteed. Furthermore, the suspension strut bearing 1 contains a damping layer 19 that is oriented radially to the center axis 7 of the suspension strut bearing 1 and forms a thrust bearing 13 for the coil spring 15, in order to achieve an oscillation-damping or noise-damping effect in the axial direction between the coil spring 15 and the suspension strut bearing 1.

The guide ring 5 is here constructed by a manufacturing method as a one-piece component such that the metallic reinforcement 17 is extrusion-coated with the plastic material of the guide ring 5 and the damping layer 19 that is made from a softer plastic material than that of the guide ring 5 is injection molded on the guide ring 5, so that a non-detachable connection is created.

A complex and assembly-ready guide ring is produced on the basis that the extrusion-coating of the metallic reinforcement 17 and the injection-molding of the damping layer 19 can be constructed in an injection mold, such as, for example, by a multi-component injection-molding method.

FIG. 2 shows a second embodiment of the suspension strut bearing 1 according to the invention with a sliding bearing 9 taken in a longitudinal section along the center axis 7, wherein here a damping layer 19 is oriented in the radial and axial direction relative to the center axis 7 of the suspension strut bearing 1, but also forms here the thrust bearing 13 for a coil spring 15, so that an oscillation-damping or noise-damping effect is achieved between a coil spring 15 and the suspension strut bearing 1 in both directions, i.e., in the radial and axial direction relative to the center axis 7.

The remaining features of this construction, including their reference symbols, are identical to the embodiment according to FIG. 1 and are therefore to be taken from the description above.

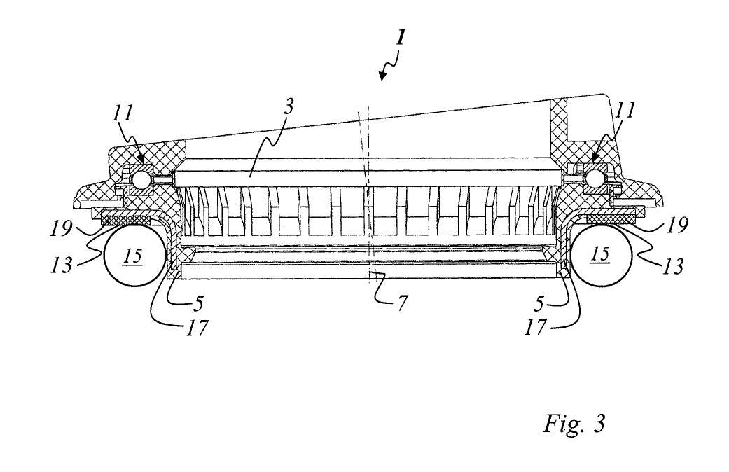

FIG. 3 shows a suspension strut bearing 1 according to the invention with a rolling bearing 11 in a longitudinal section along the center axis 7, wherein the reference symbols to be taken from this construction are identical to the suspension strut bearing 1 according to the invention and according to FIG. 1 and are therefore to be taken from the description above.

The present invention has been described with reference to preferred embodiments. Nevertheless, changes and modifications of the constructions of the suspension strut bearing proposed here and of the manufacturing method for a component of a suspension strut bearing could be realized, without leaving the scope of protection of the following claims.

### LIST OF REFERENCE SYMBOLS

1 Suspension strut bearing
3 Vehicle-body attachment element
5 Guide ring
7 Center axis
9 Sliding bearing
11 Rolling bearing
13 Thrust bearing
15 Coil spring
17 Reinforcement
19 Damping layer
21 Sliding element

1. A suspension strut bearing (1), comprising a sliding bearing (9) or rolling bearing (11) that is rotatable about a center axis (7) and is arranged between a vehicle-body attachment element (3) and a guide ring (5), the guide ring (5) has at least one metallic reinforcement (17) and forms at least one of an axial or radial thrust bearing (13) for a coil spring (15), the guide ring (5) is a one-piece component that comprises at least one damping layer (19) and the at least one metallic reinforcement (17).

2. The suspension strut bearing (1) according to claim 1, wherein the guide ring (5), the at least one metallic reinforcement (17), and the at least one damping layer (19) are connected to each other in a non-detachable way.

3. The suspension strut bearing (1) according to claim 1, wherein the at least one damping layer (19) is injection-molded on the guide ring (5).

4. The suspension strut bearing (1) according to claim 1, wherein the at least one damping layer (19) is oriented in a radial direction relative to the center axis (7) of the suspension strut bearing (1) and the at least one damping layer (19) forms the thrust bearing (13) for the coil spring (15).

5. The suspension strut bearing (1) according to claim 1, wherein the at least one damping layer (19) is oriented in a radial and an axial direction relative to the center axis (7) of the suspension strut bearing (1) and the at least one damping layer (19) forms the thrust bearing (13) for the coil spring (15).

6. The suspension strut bearing (1) according to claim 1, wherein the at least one damping layer (19) is formed of a softer plastic material than that of the guide ring (5).

7. The suspension strut bearing (1) according to claim 1, wherein the at least one metallic reinforcement (17) is extrusion-coated with the material of the guide ring (5).

8. The suspension strut bearing (1) according to claim 1, wherein a sliding element (21) allocated to the sliding bearing (9) is arranged in radial and axial directions relative to the center axis (7) of the suspension strut bearing (1), so that the suspension strut bearing (1) is adapted to absorb axial and radial forces.

9. A manufacturing method for a component of a suspension strut bearing (1), comprising the following steps:
extrusion coating at least one metallic reinforcement (17) with a material of a guide ring (5); and
injection molding at least one damping layer (19) on the guide ring (5) as at least one of an axial or radial thrust bearing (13) for a coil spring (15); and the extrusion-coating of the at least one metallic reinforcement (17) and the injection-molding of the at least one damping layer (19) are carried out in an injection mold.

10. The manufacturing method according to claim 1, wherein the extrusion-coating and injection-molding are carried out by multi-component injection-molding in the injection mold.
